(19) United States
(12) Patent Application Publication
(10) Pub. No.: US 2006/0206670 A1
(43) Pub. Date: Sep. 14, 2006

(54) Disc array controller and method of controlling cache memory in disc array controller

(75) Inventor: Hiroshi Tanoue, Tokyo (JP)

Correspondence Address: OSTROLENK, FABER, GERB & SOFFEN, LLP, 1180 AVENUE OF THE AMERICAS, NEW YORK, NY, 10036-8403, US

(73) Assignee: NEC Corporation

(21) Appl. No.: 11/371,822

(22) Filed: Mar. 9, 2006

(30) Foreign Application Priority Data
Mar. 9, 2005 (JP) 2005-65804

(51) Int. Cl. G06F 12/00

(52) U.S. Cl. 711/129

(57) ABSTRACT

The disc array controller through which data is written into and read out of a disc array, includes a cache memory, a command-monitoring device which monitors commands input into the disc array controller, and a memory controller which assigns areas of the cache memory to the commands in accordance with a rate among the commands having been monitored by the command-monitoring device.

### BACKGROUND OF THE INVENTION

1. Field of the Invention

The invention relates to a disc array controller through which data is written into and read out of a disc array, a memory-area assignor in a disc array controller through which data is written into and read out of a disc array, a method of controlling a cache memory in a disc array controller through which data is written into and read out of a disc array, and a program containing a set of instructions for causing a computer to carry out a method of controlling a cache memory in a disc array controller through which data is written into and read out of a disc array.

2. Description of the Related Art

Data is written into and read out of a disc array through a disc array controller including a cache memory.

A conventional disc array controller is usually designed to include a cache memory comprised of a semiconductor memory in order to enhance performance thereof.

In operation, a host computer provides a “read” command to a disc array controller to read data out of a disc array or a “write” command to a disc array controller to write data to a disc array. A cache memory is usually designed to have a fixed cache area (memory area) for each of a “read” command and a “write” command.

For instance, Japanese Patent Application Publication No. 8-328758 (December, 1996) has suggested a disc array unit including a plurality of discs, and first and second disc array controllers. Data having been transferred to the first disc array controller from a host computer is transferred to the second disc array controller, and stored in disc caches in the first and second disc array controllers in multiplexed condition. If the first disc array controller is out of order, data stored in the disc cache in the second disc array controller is written into the discs.

Japanese Patent Application Publication No. 11-288387 (October, 1999) has suggested an apparatus for optimizing a function of a disc cache in a RAID type disc array unit.

Japanese Patent Application Publication No. 2000-222137 has suggested a disc memory including (a) a buffer memory temporarily storing data transferred between a host system and a disc medium, (b) a judgment unit which compares an address of write data on the disc medium, the write data being transferred from the host system in accordance with a “write” command, and stored in the buffer memory, to an address of data on the disc medium, the data being read out of the disc medium, and judges whether the addresses overlap each other, and (c) a controller which, if the judgment unit judges that the addresses overlap each other, overrides an overlapped portion of the write data on an associated portion of the data read out of the disc medium.

Japanese Patent Application Publication No. 2001-125753 has suggested a disc array unit including a plurality of disc array controllers each of which controls reading data out of and writing data into a plurality of disc drives in accordance with a command received from a host, and further controls inputting data into and outputting data from a cache memory. Each of the disc array controllers includes a single cache memory which the each of the disc array controllers can use.

Japanese Patent Application Publication No. 2001-265539 has suggested an array-type memory storing data received from and transmitted to a data processor, including a plurality of memories each storing the data therein, and a broadcast type optical medium to which the data processor and the memories are connected, and which has a plurality of access ports through which data is transmitted, where the data is transmitted in the form of an optical signal.

Japanese Patent Application Publication No. 2003-345521 has suggested a disc array unit including a disc array controller having a cache memory temporarily storing data to be written into a plurality of magnetic disc mediums from a host machine. The disc array controller has a first cache memory, and each of the magnetic disc mediums has a second cache memory. The disc array controller transmits a “write” command to the second cache memory, and a “synchronization” command to storage mediums of the magnetic disc mediums. Data to be written into the first cache memory, the second cache memory and the storage mediums of the magnetic disc mediums backup one another.

However, a requisite cache area varies in accordance with a user's request or environment. Hence, it is quite difficult or almost impossible to assign an appropriate cache area to commands in a cache memory in accordance with a user's request.

### SUMMARY OF THE INVENTION

In view of the above-mentioned problems in the prior art, it is an object of the present invention to provide a disc array controller which is capable of effectively use a cache memory in accordance with a user's request or environment thereof.

It is further an object of the present invention to provide a memory-area assignor in a disc array controller, a method of controlling a cache memory in a disc array controller, and a program containing a set of instructions for causing a computer to carry out the method, all of which are capable of effectively use a cache memory in accordance with a user's request or environment thereof.

Hereinbelow are described a disc array controller, a memory-area assignor, a method of controlling a cache memory in a disc array controller, and a program containing a set of instructions for causing a computer to carry out the method, all in accordance with the present invention through the use of reference numerals used in later described embodiments. The reference numerals are indicated only for the purpose of clearly showing correspondence between claims and the embodiments. It should be noted that the reference numerals are not allowed to interpret claims of the present application.

In one aspect of the present invention, there is provided a disc array controller (1) through which data is written into and read out of a disc array, including a cache memory (6), a command-monitoring device (4) which monitors commands input into the disc array controller (1), and a memory controller (5) which assigns areas of the cache memory (6) to the commands in accordance with a rate among the commands having been monitored by the command-monitoring device (4).

It is preferable that the command-monitoring device (4) checks whether a command having been input into the disc array controller (1) is a “read” command or a “write” command, and the memory controller (5) assigns a first area (7) of the cache memory (6) to the “read” command and a second area (8) of the cache memory (6) to the “write” command in accordance with a rate between the “read” and “write” commands both having been monitored by the command-monitoring device (4).

For instance, the rate is defined as a rate between a number of “read” commands and a number of “write” commands in a predetermined period of time.

It is preferable that memory controller (5) equalizes the rate to a rate between an area for the “read” command and an area for the “write” command in the cache memory (6).

In another aspect of the present invention, there is provided a memory-area assignor in a disc array controller (1) through which data is written into and read out of a disc array, including a command-monitoring device (4) which monitors commands input into the disc array controller (1), a memory controller (5) which assigns areas of the cache memory (6) to the commands in accordance with a rate among the commands having been monitored by the command-monitoring device (4).

It is preferable that the command-monitoring device (4) checks whether a command having been input into the disc array controller (1) is a “read” command or a “write” command, and the memory controller (5) assigns a first area (7) of the cache memory (6) to the “read” command and a second area (8) of the cache memory (6) to the “write” command in accordance with a rate between the “read” and “write” commands both having been monitored by the command-monitoring device (4).

For instance, the rate is defined as a rate between a number of “read” commands and a number of “write” commands in a predetermined period of time.

It is preferable that memory controller (5) equalizes the rate to a rate between an area for the “read” command and an area for the “write” command in the cache memory (6).

In still another aspect of the present invention, there is provided a method of controlling a cache memory (6) in a disc array controller (1) through which data is written into and read out of a disc array, including (a) monitoring commands input into the disc array controller (1), and (b) assigning areas of the cache memory (6) to the commands in accordance with a rate among the commands having been monitored in the (a).

It is preferable that it is checked in the (a) whether a command having been input into the disc array controller (1) is a “read” command or a “write” command, and a first area (7) of the cache memory (6) is assigned to the “read” command and a second area (8) of the cache memory (6) is assigned to the “write” command in the (b) in accordance with a rate between the “read” and “write” commands both having been monitored in the (a).

For instance, the rate is defined as a rate between a number of “read” commands and a number of “write” commands in a predetermined period of time.

It is preferable that the rate is made equal in the (b) to a rate between an area for the “read” command and an area for the “write” command in the cache memory (6).

In yet another aspect of the present invention, there is provided a program containing a set of instructions for causing a computer to carry out a method of controlling a cache memory (6) in a disc array controller (1) through which data is written into and read out of a disc array, the set of instructions including (a) monitoring commands input into the disc array controller (1), and (b) assigning areas of the cache memory (6) to the commands in accordance with a rate among the commands having been monitored in the (a).

It is preferable that it is checked in the (a) whether a command having been input into the disc array controller (1) is a “read” command or a “write” command, and a first area (7) of the cache memory (6) is assigned to the “read” command and a second area (8) of the cache memory (6) is assigned to the “write” command in the (b) in accordance with a rate between the “read” and “write” commands both having been monitored in the (a).

For instance, the rate is defined as a rate between a number of “read” commands and a number of “write” commands in a predetermined period of time.

It is preferable that the rate is made equal in the (b) to a rate between an area for the “read” command and an area for the “write” command in the cache memory (6).

The advantages obtained by the aforementioned present invention will be described hereinbelow.

In accordance with the present invention, even if a user's request or an environment varies, it is possible to effectively assign a cache area to commands.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of a disc array controller in accordance with an embodiment of the present invention.

FIG. 2 is a flow chart showing steps to be carried out by the disc array controller in accordance with the embodiment of the present invention.

FIG. 3 shows an example of determination of an assignment rate.

FIG. 4 shows another example of determination of an assignment rate.

FIG. 5 is a block diagram of an example of a structure of the memory-area assignor.

### DESCRIPTION OF THE PREFERRED EMBODIMENT

A preferred embodiment in accordance with the present invention will be explained hereinbelow with reference to drawings.

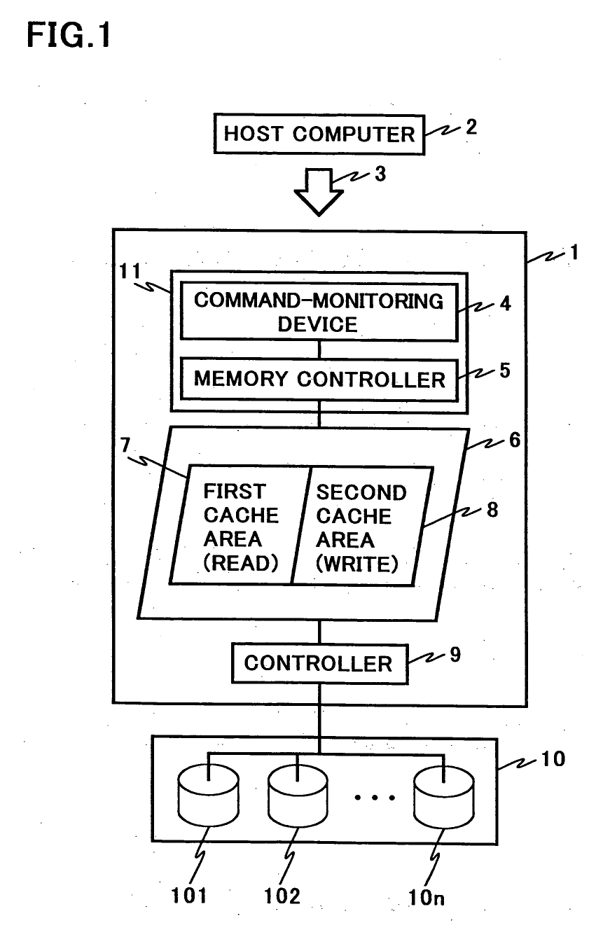

FIG. 1 is a block diagram of a disc array controller 1 in accordance with an embodiment of the present invention.

As illustrated in FIG. 1, a disc array unit 10 including a plurality of magnetic discs 101 to 10n therein is operably connected to the disc array controller 1.

The disc array controller 1 receives a command 3 from a host computer 2.

The disc array controller 1 is comprised of a memory-area assignor 11, a cache memory 6, and a controller 9.

The memory-area assignor 11 is comprised of a command-monitoring device 4, and a memory controller 5.

The cache memory 6 includes a first cache area 7 for “read” commands and a second cache area 8 for “write” commands.

The controller 9 controls data communication among the discs 101 to 10n, the cache memory 6, and the host computer 2 in response to the received command 3.

On receipt of the command 3 from the host computer 2, the command-monitoring device 4 of the memory-area assignor 11 identifies a kind of the received command 3. For instance, the command-monitoring device 4 checks whether the received command 3 is a “read” command or a “write” command.

The memory controller 5 receives the identification result from the command-monitoring device 4. Then, the memory controller 5 assigns an area in the cache memory 6 to the received command in accordance with the identification result received from the command-monitoring device 4. For instance, if the received command 3 is a “read” command, the memory controller 5 assigns the first cache area 7 to the received command 3.

If the received command 3 is a “read” command, the controller 9 reads data out of the discs 101 to 10n and stores the thus read-out data into the first cache area 7 of the cache memory 6, and if the received command 3 is a “write” command, the controller 9 writes data stored in the second cache area 8 of the cache memory 6, into the discs 101 to 10n.

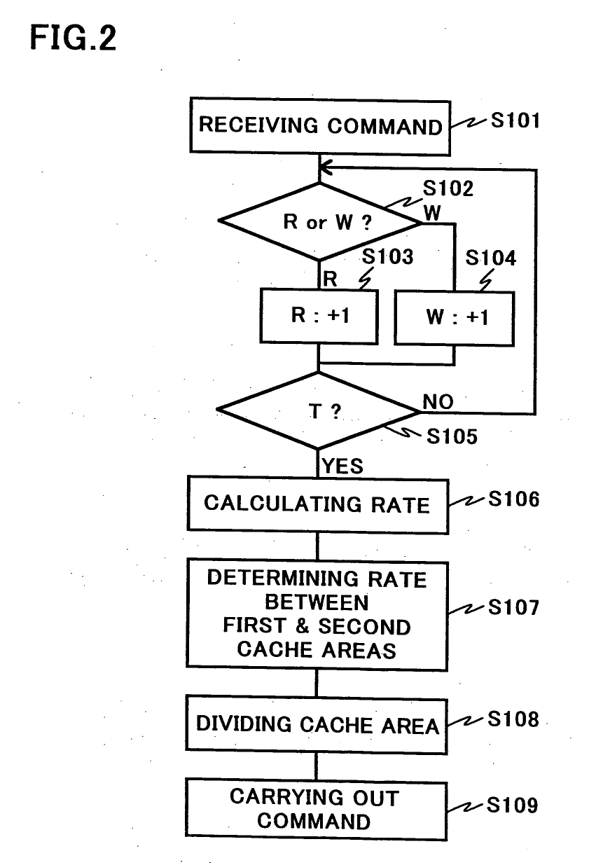

FIG. 2 is a flow chart showing steps to be carried out by the disc array controller 1 in accordance with the embodiment.

Hereinbelow is explained an operation of the disc array controller 1 with reference to FIG. 2.

On receipt of the command 3 from the host computer 2 (step S101), the command-monitoring device 4 of the memory-area assignor 11 checks whether the received command 3 is a “read” command or a “write” command (step S102).

The command-monitoring device 4 transmits the check result to the memory controller 5.

The memory controller 5 includes a first counter (not illustrated) for counting a number of “read” commands and a second counter (not illustrated) for counting a number of “write” commands.

If the check result received from the command-monitoring device 4 indicates that the received command 3 was a “read” command (R in step S102), the memory controller 5 counts up the first counter (step S103). If the check result received from the command-monitoring device 4 indicates that the received command 3 was a “write” command (W in step S102), the memory controller 5 counts up the second counter (step S104).

The command-monitoring device 4 continues checking whether the received command 3 is a “read” command or a “write” command (step S102), in a predetermined period of time T. For instance, the predetermined period of time T is 30 seconds.

The memory controller 5 includes a timer (not illustrated) therein. The memory controller 5 checks whether the predetermined period of time T has passed or not (step S105).

If he predetermined period of time T has not passed yet (NO in step S105), the command-monitoring device 4 continues checking whether the received command 3 is a “read” command or a “write” command (step S102), and the memory controller 5 continues counting the commands 3.

If the predetermined period of time T has passed (YES in step S105), the memory controller 5 instructs the command-monitoring device 4 to stop checking whether the received command 3 is a “read” command or a “write” command, and calculates a rate between the “read” and “write” commands having been received in the predetermined period of time T (step S106).

Then, the memory controller 5 determines a rate between the first cache area 7 and the second cache area 8 in the cache memory 6 in accordance with the above-mentioned rate between the “read” and “write” commands having been received in the predetermined period of time T (step S107).

The memory controller 5 divides an area of the cache memory 6 into the first cache area 7 and the second cache area 8 in accordance with the thus determined rate (step S108).

Then, the controller 9 carries out the received command 3 (step S109).

Specifically, if the received command 3 is a “read” command, the controller 9 reads data out of the discs 101 to 10n and stores the thus read-out data into the first cache area 7 of the cache memory 6, and if the received command 3 is a “write” command, the controller 9 writes data stored in the second cache area 8 of the cache memory 6, into the discs 101 to 10n.

As mentioned above, the memory controller 5 divides an area of the cache memory 6 into the first cache area 7 and the second cache area 8 in accordance with the determined rate between the “read” and “write” commands having been received in the predetermined period of time T.

For instance, if the command-monitoring device 4 identifies 80% of the received commands 3 as a “read” command and the rest of 20% as a “write” command, the memory controller 5 assigns 80% of an area of the cache memory 6 to the first cache area and the rest of 20% to the second cache area.

The memory controller 5 dynamically varies the assignment rate to keep it always appropriate.

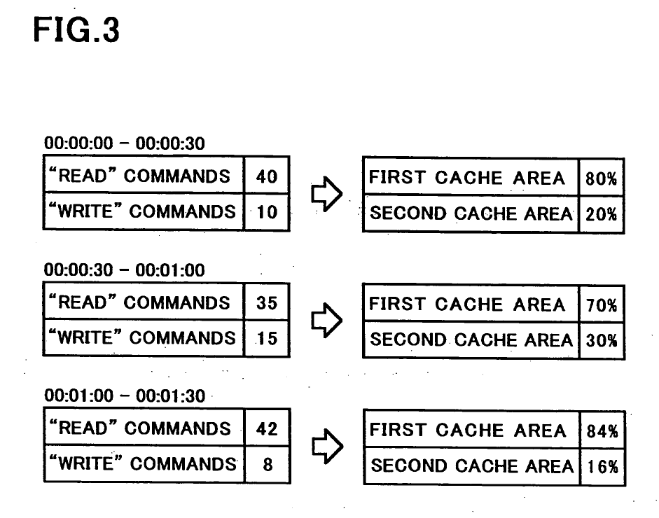

FIG. 3 shows an example of how the memory controller 5 determines the assignment rate.

In the example shown in FIG. 3, the predetermined period of time T is set equal to 30 seconds.

If a number of “read” commands is 40 and a number of “write” commands is 10 in the first 30 seconds (00:00:00-00:00:30), the memory controller 5 assigns 80% of an area of the cache memory 6 to the first cache area and the rest of 20% to the second cache area.

If a number of “read” commands is 35 and a number of “write” commands is 15 in the second 30 seconds (00:00:30-00:01:00), the memory controller 5 assigns 70% of an area of the cache memory 6 to the first cache area and the rest of 30% to the second cache area.

If a number of “read” commands is 42 and a number of “write” commands is 8 in the third 30 seconds (00:01:00-00:01:30), the memory controller 5 assigns 84% of an area of the cache memory 6 to the first cache area and the rest of 16% to the second cache area.

Thereafter, the memory controller 5 determines the assignment rate in the same way.

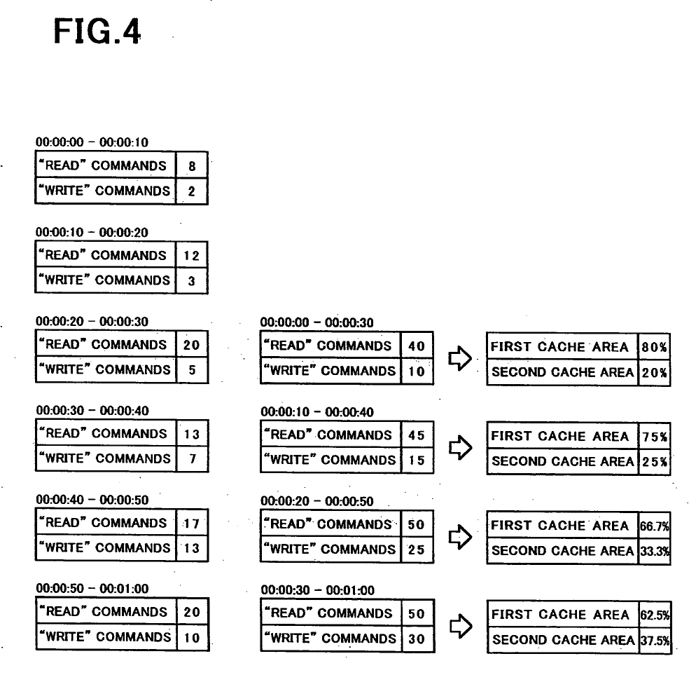

FIG. 4 shows another example of how the memory controller 5 determines the assignment rate.

In the example shown in FIG. 4, the memory controller 5 is designed to count numbers of “read” and “write” commands in the immediately past 30 seconds, but update the counts every 10 seconds.

As shown in FIG. 4, it is assumed that a number of “read” commands in the first to sixth 10 seconds is 8, 12, 20, 13, 17 and 20, respectively, and a number of “write” commands in the first to sixth 10 seconds is 2, 3, 5, 7, 13 and 10, respectively.

The memory controller 5 counts total numbers of “read” and “write” commands in the first immediately past 30 seconds (00:00:00-00:00:30). Since a total number of “read” commands in the first immediately past 30 seconds is 40 and a total number of “write” commands in the first immediately past 30 seconds is 10, the memory controller 5 assigns 80% (40/(40+10)) of an area of the cache memory 6 to the first cache area and the rest of 20% to the second cache area.

After 10 seconds later, the memory controller 5 counts total numbers of “read” and “write” commands in the second immediately past 30 seconds (00:00:10-00:00:40). Since a total number of “read” commands in the second immediately past 30 seconds is 45 and a total number of “write” commands in the first immediately past 30 seconds is 15, the memory controller 5 assigns 75% (45/(45+15)) of an area of the cache memory 6 to the first cache area and the rest of 25% to the second cache area.

After further 10 seconds later, the memory controller 5 counts total numbers of “read” and “write” commands in the third immediately past 30 seconds (00:00:20-00:00:50). Since a total number of “read” commands in the third immediately past 30 seconds is 50 and a total number of “write” commands in the first immediately past 30 seconds is 25, the memory controller 5 assigns 66.7% (50/(50+25)) of an area of the cache memory 6 to the first cache area and the rest of 33.3% to the second cache area.

After further 10 seconds later, the memory controller 5 counts total numbers of “read” and “write” commands in the fourth immediately past 30 seconds (00:00:30-00:01:00). Since a total number of “read” commands in the third immediately past 30 seconds is 50 and a total number of “write” commands in the first immediately past 30 seconds is 30, the memory controller 5 assigns 62.5% (50/(50+30)) of an area of the cache memory 6 to the first cache area and the rest of 37.5% to the second cache area.

Thereafter, the memory controller 5 determines the assignment rate in the same way.

In the examples shown in FIGS. 3 and 4, the memory controller 5 equalizes the assignment rate to a rate between numbers of “read” and “write” commands having been counted in the predetermined period of time. However, it is not always necessary to equalize the assignment rate to a rate between numbers of “read” and “write” commands. The memory controller 5 may be designed to determine the assignment rate in different ways from the examples shown in FIGS. 3 and 4.

For instance, as a variance of the example shown in FIG. 3, if a number of “read” commands is 40 and a number of “write” commands is 10 in the predetermined period of time, the memory controller 5 may assign 88% (1.1×40/(40+10)) of an area of the cache memory 6 to the first cache area and the rest of 12% to the second cache area. That is, the memory controller 5 may use a coefficient (1.1) which is determined in accordance with a lot of factors.

In accordance with the above-mentioned embodiment, it is possible to assign an area of the cache memory 6 to the first and second cache areas 7 and 8 in accordance with an environment in which the disc array controller 1 is used. Hence, the cache memory 6 can be optimally used, ensuring enhancement in performance of a system including the disc array controller 1.

In addition, it is possible for a user to keep optimal environment, even if an environment in which a user uses the disc array controller 1 varies.

For instance, the disc array controller 1 in accordance with the embodiment may be applied to a server, a workstation or a personal computer.

The memory-area assignor 11 in the disc array controller 1 it is possible to assign an area of the cache memory 6 to the first and second cache areas 7 and 8 in accordance with an environment in which the disc array controller 1 is used. Hence, the cache memory 6 can be optimally used, ensuring enhancement in performance of a system including the disc array controller 1.

The memory-area assignor 11 is used in the disc array controller 1 in the above-mentioned embodiment. It should be noted that the memory-area assignor 11 may be used in any electronic devices which is required to optimally use a cache memory in accordance with an environment in which it is used. For instance, the memory-area assignor 11 may be applied to a server, a workstation or a personal computer.

In the above-mentioned embodiment, the memory-area assignor 11 including the command-monitoring device 4 and the memory controller 5 is comprised of hardware.

It should be noted that the functions provided by the memory-area assignor 11 may be accomplished by a software program.

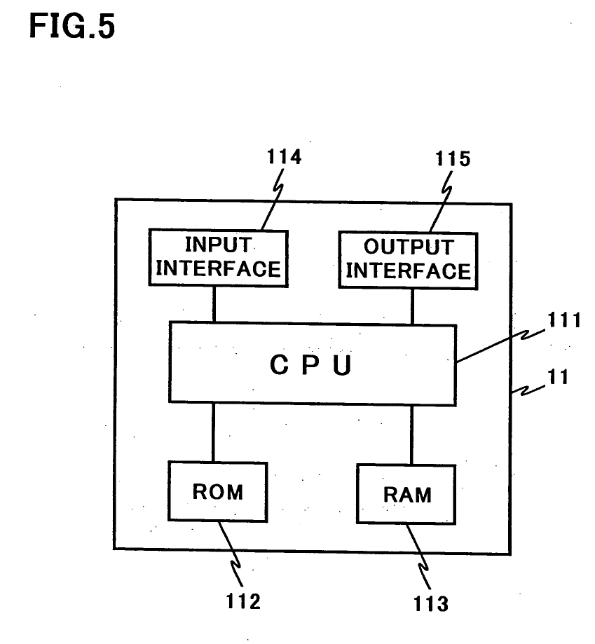

FIG. 5 is a block diagram of an example of a structure of the memory-area assignor 11.

As illustrated in FIG. 5, the memory-area assignor 11 is comprised of a central processing unit (CPU) 111, a first memory 112, a second memory 113, an input interface 114 through which a command and/or data is input into the central processing unit 111, and an output interface 115 through which a result of steps having been executed by the central processing unit 111 is output.

The first memory 112 is comprised of a read only memory (ROM), and the second memory 113 is comprised of a random access memory (RAM).

The first memory 112 stores therein a program for carrying out the functions of the memory-area assignor 11. The second memory 113 stores therein various data and parameters, and presents a working area to the central processing unit 111.

The central processing unit 111 reads the program out of the first memory 112, and executes the program. Thus, the central processing unit 111 operates in accordance with the program stored in the first memory 112.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2005-065804 filed on Mar. 9, 2005 including specification, claims, drawings and summary is incorporated herein by reference in its entirety.

What is claimed is:

1. A disc array controller through which data is written into and read out of a disc array, comprising:
a cache memory;
a command-monitoring device which monitors commands input into said disc array controller; and
a memory controller which assigns areas of said cache memory to said commands in accordance with a rate among said commands having been monitored by said command-monitoring device.

2. The disc array controller as set forth in claim 1, wherein said command-monitoring device checks whether a command having been input into said disc array controller is a “read” command or a “write” command, and
said memory controller assigns a first area of said cache memory to said “read” command and a second area of said cache memory to said “write” command in accordance with a rate between said “read” and “write” commands both having been monitored by said command-monitoring device.

3. The disc array controller as set forth in claim 2, wherein said rate is defined as a rate between a number of “read” commands and a number of “write” commands in a predetermined period of time.

4. The disc array controller as set forth in claim 2, wherein memory controller equalizes said rate to a rate between an area for said “read” command and an area for said “write” command in said cache memory.

5. A memory-area assignor in a disc array controller through which data is written into and read out of a disc array, comprising:
a command-monitoring device which monitors commands input into said disc array controller;
a memory controller which assigns areas of said cache memory to said commands in accordance with a rate among said commands having been monitored by said command-monitoring device.

6. The memory-area assignor as set forth in claim 5, wherein said command-monitoring device checks whether a command having been input into said disc array controller is a “read” command or a “write” command, and
said memory controller assigns a first area of said cache memory to said “read” command and a second area of said cache memory to said “write” command in accordance with a rate between said “read” and “write” commands both having been monitored by said command-monitoring device.

7. The memory-area assignor as set forth in claim 6, wherein said rate is defined as a rate between a number of “read” commands and a number of “write” commands in a predetermined period of time.

8. The memory-area assignor as set forth in claim 6, wherein memory controller equalizes said rate to a rate between an area for said “read” command and an area for said “write” command in said cache memory.

9. A method of controlling a cache memory in a disc array controller through which data is written into and read out of a disc array, comprising:
(a) monitoring commands input into said disc array controller; and
(b) assigning areas of said cache memory to said commands in accordance with a rate among said commands having been monitored in said (a).

10. The method as set forth in claim 9, wherein it is checked in said (a) whether a command having been input into said disc array controller is a “read” command or a “write” command, and
a first area of said cache memory is assigned to said “read” command and a second area of said cache memory is assigned to said “write” command in said (b) in accordance with a rate between said “read” and “write” commands both having been monitored in said (a).

11. The method as set forth in claim 10, wherein said rate is defined as a rate between a number of “read” commands and a number of “write” commands in a predetermined period of time.

12. The method as set forth in claim 10, wherein said rate is made equal in said (b) to a rate between an area for said “read” command and an area for said “write” command in said cache memory.

13. A program containing a set of instructions for causing a computer to carry out a method of controlling a cache memory in a disc array controller through which data is written into and read out of a disc array, the set of instructions comprising:
(a) monitoring commands input into said disc array controller; and
(b) assigning areas of said cache memory to said commands in accordance with a rate among said commands having been monitored in said (a).

14. The program as set forth in claim 13, wherein it is checked in said (a) whether a command having been input into said disc array controller is a “read” command or a “write” command, and
a first area of said cache memory is assigned to said “read” command and a second area of said cache memory is assigned to said “write” command in said (b) in accordance with a rate between said “read” and “write” commands both having been monitored in said (a).

15. The program as set forth in claim 14, wherein said rate is defined as a rate between a number of “read” commands and a number of “write” commands in a predetermined period of time.

16. The program as set forth in claim 14, wherein said rate is made equal in said (b) to a rate between an area for said “read” command and an area for said “write” command in said cache memory.
